(19) United States
(12) Patent Application Publication
(10) Pub. No.: US 2024/0140869 A1
(43) Pub. Date: May 2, 2024

(54) CEMENT-BASED PERVIOUS PAVEMENT STRUCTURE, MANUFACTURING METHOD AND APPLICATION THEREOF

(71) Applicant: Hip Hing Construction Technology Ltd, Hong Kong (CN)

(72) Inventors: Tat Chi CHU, Hong Kong (CN); Kwok Leung SO, Hong Kong (CN); Pui Lam NG, Hong Kong (CN); Chung Kong CHAU, Hong Kong (CN); Yong FAN, Hong Kong (CN); Shuai ZOU, Hong Kong (CN); Man Lung SHAM, Hong Kong (CN)

(73) Assignee: Hip Hing Construction Technology Ltd, Hong Kong (CN)

(21) Appl. No.: 18/378,670

(22) Filed: Oct. 11, 2023

(30) Foreign Application Priority Data
Oct. 28, 2022 (CN) 202211338597.1

(51) Int. Cl. C04B 28/04; C04B 14/22; C04B 14/30; C04B 18/14; E01C 7/14; E01C 11/22

(52) U.S. Cl. CPC C04B 28/04; C04B 14/22; C04B 14/305; C04B 18/146; E01C 7/142; E01C 11/226; C04B 2111/0075

(57) ABSTRACT

The present application relates to the technical field of road infrastructure, and provides a cement-based pervious pavement structure, a manufacturing method of the cement-based pervious pavement structure, and an application of the cement-based pervious pavement structure. The cement-based pervious pavement structure includes: a lower structural layer as the base; an upper surfacing layer overlaid on said lower structural layer and including: 1.0-2.0 parts by weight of upper layer (fine) aggregate; 0.40-0.70 part by weight of cement; 0.02-0.03 part by weight of titanium dioxide; 0.03-0.04 part by weight of water reducing agent; 0.001-0.002 part by weight of defoamer. The cement-based pervious pavement structure provided by the present application can provide air purification function taking into account the practical cost.

### TECHNICAL FIELD

The present disclosure relates to the technical field of road infrastructure, and more particularly, to a cement-based pervious pavement structure, a manufacturing method of the cement-based pervious pavement structure and an application of the cement-based pervious pavement structure.

### BACKGROUND

With accelerating urbanization, the urban surface is gradually covered by water-resistant materials such as buildings and various concrete. The proportion of impervious area is greatly increased, and the coverage rate of the impervious area in some regions has exceeded 80%. As the drainage capacity of cities is getting worse and worse, when many cities encounter heavy rain, the rainwater on the road surface cannot leak quickly, which easily leads to urban water logging.

In order to solve the problem of urban ground surface hardening, European and American countries began to study pervious pavement materials in 1980s.

The pervious pavement refers to a form of pavement that materials with good water permeability and high voidage are applied to road surface layer, base and even to soil foundation. On the premise of ensuring a certain road design strength and durability, the pervious pavement can make rainwater smoothly enter inside of the pavement structure, flow through the basement layer with a temporary water storage capacity, and directly penetrate into the soil foundation or discharge from the drainage pipe inside the pavement, thus achieving the purpose of rainwater seepage underground and reducing ground surface runoff. The cement-based pervious pavement structure has good water permeability and air permeability. On the one hand, the cement-based pervious pavement structure solves the problem of rainwater runoff, alleviates the flood disaster, and supplements the groundwater level. On the other hand, the cement-based pervious pavement structure has many advantages, such as anti-skid, noise reduction, road reflection reduction, and “heat island effect” alleviation, and has been widely used.

In addition, with accelerating urbanization, the exhaust pollution from automobiles and factories is becoming more and more serious. The cement-based pervious pavement structure of the prior art often does not have the ability to neutralize air pollution, or has the disadvantages of high cost and high energy consumption.

### SUMMARY

To resolve or alleviate the above technical problem, the present disclosure provides a cement-based pervious pavement structure, a manufacturing method of the cement-based pervious pavement structure, and an application of the cement-based pervious pavement structure.

The cement-based pervious pavement structure includes:
a lower structural layer, as a base; and
an upper surfacing layer, overlaid on the lower structural layer, and including following components in parts by weight:
1.0-2.0 parts by weight of upper layer (fine) aggregate;
0.40-0.70 part by weight of cement;
0.02-0.03 part by weight of titanium dioxide;
0.03-0.04 part by weight of water reducing agent; and
0.001-0.002 part by weight of defoamer.

Further, optionally, the upper surfacing layer includes the following components in parts by weight:
1.5-2.0 parts by weight of upper layer (fine) aggregate;
0.50-0.70 part by weight of cement;
0.02-0.03 part by weight of titanium dioxide;
0.03 part by weight of water reducing agent; and
0.001 part by weight of defoamer.

Optionally, the upper layer (fine) aggregate includes waste glass, and a particle size of the upper layer (fine) aggregate is within a range of 1.18-2.36 mm.

Optionally, a thickness of the upper surfacing layer is less than or equal to 5 mm.

Optionally, the lower structural layer includes the following components in parts by weight:
4-6 parts by weight of lower layer aggregate, having a particle size within a range of 5-10 mm;
1.0-2.0 parts by weight of portland cement;
0.15-0.30 part by weight of fly ash;
0.20-0.50 part by weight of silica fume;
0.10-0.25 part by weight of water reducing agent; and
0.001-0.002 part by weight of defoamer.

Optionally, the lower structural layer includes the following components in parts by weight:
4-5 parts by weight of lower layer aggregate;
1.5-2.0 parts by weight of portland cement;
0.2 part by weight of fly ash;
0.3 part by weight of silica fume;
0.15 part by weight of water reducing agent; and
0.001 part by weight of defoamer;
wherein, the particle size of the lower layer aggregate is within the range of 5-10 mm.

Optionally, a ratio of the thickness of the upper surfacing layer to the thickness of the lower structural layer is within a range of 1:49 to 1:9.

Optionally, no through hole is provided on the cement-based pervious pavement structure.

Optionally, a pendulum sliding resistance BPN of the upper surfacing layer is greater than or equal to 45, and a removal rate of nitrogen oxides (NOx) of the upper surfacing layer is ≥1 mg/m²/hr.

Optionally, a compressive strength of the cement-based pervious pavement structure is higher than 28 MPa;
solid content in rainwater passing through cement-based pervious pavement structure is less than 1%; and
a water permeability of the cement-based pervious pavement structure is higher than 77 mm/hr.

The application of the foregoing cement-based pervious pavement structure is applied to a drainage cover of a drainage channel or a manhole cover of a drainage system.

The manufacturing method of the cement-based pervious pavement structure includes the following steps:
placing a concrete mixture for the lower structural layer in a mold, and applying vibration;
applying pressure to compact the concrete mixture for the lower structural layer to form the intact lower structural layer, with the water permeability of the lower structural layer being also higher than 77 mm/hr;
placing a concrete mixture for the upper surfacing layer in the mold and onto the lower structural layer, and applying vibration; and
applying pressure to compact the concrete mixture for the upper surfacing layer to form the intact upper surfacing layer.

The present disclosure adopts nano-level functional modifier and modern concrete technology, innovative and sustainable design of high-performance pervious concrete core, modern concrete production technique, various recycled materials, functional additives and other materials, and finally a cement-based pervious pavement structure with compressive strength higher than 28 MPa, water permeability higher than 77 mm/hr and filtered rainwater solid content at least 510% can be obtained.

The present disclosure also adopts technologies such as nano-modification technology, cement materials, inorganic-based pigments, recycled waste glass cullets, and nano-level functional modifiers, as well as the upper surfacing layer designed for mosquito oviposition prevention, which can greatly reduce the mosquito oviposition rate in the environment, ensure the removal rate of nitrogen oxides (NOx) to be at least ≥1 mg/m²/hr, and the pendulum sliding resistance to be BPN≥45, with excellent technical parameters.

### BRIEF DESCRIPTION OF THE DRAWINGS

In order to explain embodiments of the present disclosure more clearly, the following will briefly introduce relevant accompanying drawings. It can be understood that the accompanying drawings in the following description are only used to illustrate some embodiments of the present disclosure, and those skilled in the art can also obtain other technical features, connection relationships and so on not mentioned herein according to these accompanying drawings.

FIG. 1 is a perspective schematic diagram of a cement-based pervious pavement structure provided by the present disclosure; and

FIG. 2 is a partial enlarged schematic diagram of area A in FIG. 1.

The reference numbers and names in the accompanying drawings are as follows:
1. lower structural layer; 2. upper surfacing layer.

### DETAILED DESCRIPTION

The technical solution in embodiments of the present disclosure will be illustrated in detail below with reference to the drawings in embodiments of the present disclosure.

The applicant is aware that there have been many kinds of cement-based pervious pavement structures in the prior art.

For example, in the China Invention Patent with the application number of 202210869150.0, entitled “HOLLOW AGGREGATE COMPOSITE PHASE CHANGE MATERIAL ENERGY STORAGE PERVIOUS BRICK AND PREPARATION METHOD THEREOF”, a pervious brick with raw materials including cement, fly ash, silica fume, mineral powder, river sand, hollow aggregate adsorbed with phase change materials, water reducing agent, cellulose ether and water is disclosed. The pervious brick has a high heat storage capacity, can effectively prevent and control the urban heat island effect, and provide a reliable guarantee for the construction of sponge city.

For another example, in the China Invention Patent with the application number of 201910630860.6, entitled “RECYCLED AGGREGATE PERVIOUS BRICK AND PREPARATION METHOD THEREOF”, a recycled aggregate pervious brick with a base layer including 95-105 parts by weight of recycled aggregate, 14-16 parts by weight of cement, 14-16 parts by weight of fly ash and 0.22-0.32 part by weight of water reducing agent is disclosed. By using the recycled aggregate, the consumption of cement is reduced, and the recycled aggregate pervious brick has high compressive strength and water permeability. Meanwhile, the molding way is quick and simple, and the cost is low, which can effectively reduce environmental pollution and is suitable for large-scale industrial production.

None of the above cement-based pervious pavement structures has the air purification function. With the rapid development of urbanization, the pollution from nitrogen oxides in the emissions from factories and cars is becoming increasingly serious, which puts forward new requirements for the pavement structure to degrade these pollution gas. In the prior art, the applicant is aware of some ceramic pervious bricks and sand-based pervious bricks with the air purification function. However, the cost of these kinds of pervious bricks is remarkably higher than that of cement pervious bricks, and it is difficult to be widely used.

After comparison, the applicant believes that there is no pervious pavement structure in the market that can take into account both the cost and the air purification function. In view of this, the applicant put forward the technical scheme of the present disclosure.

A first embodiment of the present disclosure proposes a cement-based pervious pavement structure and a manufacturing method of the cement-based pervious pavement structure.

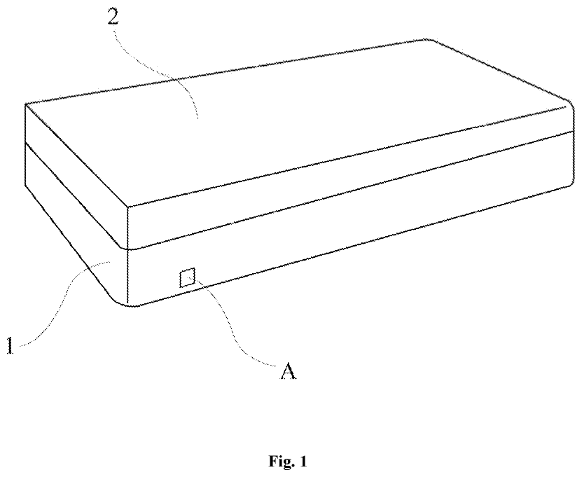

The cement-based pervious pavement structure, as shown in FIG. 1, includes:
a lower structural layer serves, as a base; and
an upper surfacing layer, overlaid on the lower structural layer, and including the following components in parts by weight:
1.0-2.0 parts by weight of upper layer (fine) aggregate;
0.40-0.70 part by weight of cement;
0.02-0.03 part by weight of titanium dioxide;
0.03-0.04 part by weight of water reducing agent; and
0.001-0.002 part by weight of defoamer.

Titanium dioxide is inorganic substance with the chemical formula of TiO2. Titanium dioxide is a white solid or powder, which has no toxicity, excellent opacity, excellent whiteness and brightness, so the titanium dioxide is considered as the best white pigment in the world. More importantly, titanium dioxide can be used as a photocatalyst to participate in the decomposition of nitrogen oxides without being consumed in chemical reactions.

In the present disclosure, by doping titanium dioxide particles in the components of the upper surfacing layer, the cement-based pervious pavement structure can have the effect of purifying nitrogen oxides. Compared with the cement-based pervious pavement structure in the prior art, the present disclosure has a function of purifying and degrading polluted gas, while compared with the ceramic pervious brick or sand-based pervious brick in the prior art, the cement-based pervious pavement structure does not need washing, drying, heating, sintering and other steps, and both the material cost and the manufacturing cost are more controllable.

In the present disclosure, components and example of an upper surfacing layer mix are given, which can be seen in the following table:

TABLE 1

| | | | Water | | | | |
|---|---|---|---|---|---|---|---|
| | | | reducing | Waste | | | Total |
| | Cement | TiO₂ | agent | glass | Defoamer | Water | mass |
| Type | Green Island | Aeroxide | PCA I | 1.18-2.36 mm | P803 | | |
| | white 525 | P25 | | | | | |
| Parts by | 0.40-0.70 | 0.02-0.03 | 0.03-0.04 | 1.0-2.0 | 0.001-0.002 | 0.1-0.2 | 2.0-3.0 |
| weight | | | | | | | |

In view of the above scope, the present disclosure gives specific embodiments and comparative examples of the upper surfacing layer mixes as follows:

TABLE 2

| | | | | Water | | | |
|---|---|---|---|---|---|---|---|
| Number of embodiments and | | | | reducing | Waste | | |
| comparative examples | | Cement | TiO₂ | agent | glass | Defoamer | Water |
| Variable: | 1 | 0.5 | 0.02 | 0.03 | 1.5 | 0.01 | 0.15 |
| TiO₂ | 2 | 0.5 | 0.03 | 0.03 | 1.5 | 0.01 | 0.15 |
| | 3 | 0.5 | 0.04 | 0.03 | 1.5 | 0.01 | 0.15 |
| | Comparative | 0.5 | 0.0 | 0.03 | 1.5 | 0.01 | 0.1 |
| | example | | | | | | |
| Variable: | 4 | 0.4 | 0.02 | 0.03 | 1.5 | 0.01 | 0.1 |
| cement | 5 | 0.7 | 0.02 | 0.03 | 1.5 | 0.01 | 0.1 |
| | Comparative | 0.8 | 0.02 | 0.03 | 1.5 | 0.01 | 0.1 |
| | example | | | | | | |
| Variable: | 7 | 0.7 | 0.02 | 0.03 | 1.0 | 0.01 | 0.1 |
| waste | 8 | 0.7 | 0.02 | 0.03 | 1.5 | 0.01 | 0.1 |
| glass | 9 | 0.7 | 0.02 | 0.03 | 2.0 | 0.01 | 0.1 |
| | Comparative | 0.7 | 0.02 | 0.03 | 2.2 | 0.01 | 0.1 |
| | example | | | | | | |

For the above embodiments and comparative examples, the present disclosure gives the specific test results as follows:

TABLE 3

| | | Water | Sliding | Removal value |
|---|---|---|---|---|
| Number of embodiments | | permeability | resistance | of Nitrogen |
| and comparative examples | | (mm/s) | (BPN) | oxides (mg/m²) |
| Variable: | 1 | 1.50 | 48 | 1.5 |
| titanium | 2 | 1.52 | 48 | 3.2 |
| dioxide | 3 | 1.52 | 49 | 3.3 |
| | Comparative | 1.48 | 50 | 0 |
| | example | | | |
| Variable: | 4 | 3.2 | 45 | 1.5 |
| cement | 5 | 1.4 | 55 | 1.3 |
| | Comparative | 0.5 | 60 | 1.0 |
| | example | | | |
| Variable: | 7 | 0.4 | 58 | 1.2 |
| waste | 8 | 1.4 | 55 | 1.3 |
| glass | 9 | 1.6 | 48 | 1.9 |
| | Comparative | 2.5 | 40 | 2.0 |
| | example | | | |

According to the Above Test Results:

1. For Titanium Dioxide

In the upper surfacing layer, the amount of the titanium dioxide can directly affect the removal value of nitrogen oxides. Theoretically, the higher the content of the titanium dioxide, the better the effect will be. According to Embodiment 1, Embodiment 2 and Embodiment 3, there is indeed such a trend. However, in Embodiment 3, the amount of the titanium dioxide is increased by one third with respect to Embodiment 2, but the removal value is only increased by 0.1 mg/m² with respect to Embodiment 2, which was almost negligible. The cost of the titanium dioxide is high. In addition, because the titanium dioxide is a kind of particle with large specific surface area, the higher proportion it is added in exposure to the atmosphere, the greater the influence it has on the working performance of upper surfacing layer. Therefore, from the point of view of cost-benefit, or from the point of view of practical performance, it is the best to choose 0.02-0.03 part by weight of the titanium dioxide. The removal rate of nitrogen oxides (NOx) by upper surfacing layer can reach ≥1 mg/m²/hr by doping TiO₂ of the above ratio. This is of great benefit to the air quality improvement of urban environment.

2. For Cement

In the upper surfacing layer, the cement is used as a binding material, therefore the content of cement will have a direct impact on the strength and working performance of the upper surfacing layer. When the amount of the cement is too small, the binding material is insufficient, and the bonding between the cement and glass sand is not firm, which will lead to a decrease of strength. When the amount of the cement is too high, there are excessive binding materials, and interstices that should exist will be blocked, which will eventually lead to a decrease of the water permeability. It can be seen from Embodiment 4 and Embodiment 5 that when the cement material is in the range of 0.4 to 0.7, the water permeability decreases from 3.2 mm/s to 1.4 mm/s due to increase in cement content, which is still within the acceptable range. However, when the part by weight of the cement material reaches 0.8, the water permeability drops sharply to 0.5 mm/s, which is inadequate to meet the basic requirements of pervious pavement. Therefore, in the present disclosure, the cement dosage in the range of 0.4-0.7 part by weight is selected, which gives consideration to both the performance of water permeability and strength, and is practically a better solution. In addition, it can be seen from the results in the above table that with the increase of the cement content in the range of 0.4-0.8, the sliding resistance of the prepared upper surfacing layer also shows an increasing trend, and the removal value of the nitrogen oxides shows a decreasing trend. It illustrates that in the upper surfacing layer of the present disclosure, the amount of cement can also affect the removal of the nitrogen oxides.

3. For Waste Glass

In the present disclosure, the waste glass takes the form of sand as a raw material, which is the aggregate of upper surfacing layer. There is a trade-off between the waste glass and the cement. When the amount of the waste glass is too much, the binding material is relatively insufficient, or vice versa. As can be seen from the table, the relationship between the amount of the waste glass and the water permeability is in line with our expectation of its relationship with the binding material. However, when the part by weight of the waste glass is in the range of 1.0 to 2.0, its sliding resistance fluctuates in the range of 58-48, and the performance meets requirements. However, when the part by weight of the waste glass reaches 2.2, the sliding resistance will drop sharply to 40, which is inadequate to meet the requirements. Moreover, the overall strength of the upper surfacing layer will also decrease. In addition, from the results in the above table, it can be seen that with the increase of the amount of the waste glass within the range of 1.0-2.2, the removal value of nitrogen oxides of the prepared upper surfacing layer also shows an increasing trend. It illustrates that in the upper surfacing layer of the present disclosure, the amount of the waste glass can also affect the removal of nitrogen oxides.

In the present disclosure, the upper layer (fine) aggregate can also adopt traditional aggregate materials. Recycled waste glass is used as the aggregate, which has lower cost and is more friendly to the environment. The waste glass of 1.18-2.36 mm is adopted with proper cement bonding so as to give consideration to the water permeability, surface smoothness and compressive strength, this makes the pendulum sliding resistance BPN of the upper surfacing layer greater than or equal to 45, and makes the cement-based pervious pavement structure have considerable anti-sliding ability, so that the cement-based pervious pavement structure can be applied to the pavement and provide enough friction for vehicles.

As an alternative of the present disclosure, the lower structural layer includes the following components in parts by weight:
4-6 parts by weight of lower layer aggregate, the particle size of which is within a range of 5-10 mm;
1.0-2.0 parts by weight of portland cement;
0.15-0.30 part by weight of fly ash;
0.20-0.50 part by weight of silica fume;
0.10-0.25 part by weight of water reducing agent; and
0.001-0.002 part by weight of defoamer.

In the present disclosure, components and example of a lower structural layer mix are also given, which can be seen in the following table:

TABLE 4

| | | | | Water | | | | |
|---|---|---|---|---|---|---|---|---|
| | Portland | | Silica | reducing | | | | Total |
| | cement | Fly ash | fume | agent | Aggregate | Defoamer | Water | mass |
| Type | Green | From HK | Elkem | PCA I | 5-10 mm | P803 | | |
| | Island | Electric | 920ED | | | | | |
| | 525 | Co. | | | | | | |
| Parts by | 1.0-2.0 | 0.15-0.30 | 0.20-0.50 | 0.10-0.25 | 4.0-6.0 | 0.001-0.002 | 0.2-0.35 | 9.0-11.0 |
| weight | | | | | | | | |

In view of the above scope, the present disclosure gives specific embodiments and comparative examples of the lower structural layer mixes as follows:

TABLE 5

| | | | | | Water | | | |
|---|---|---|---|---|---|---|---|---|
| Number of embodiments and | | Portland | | Silica | reducing | | | |
| comparative examples | | cement | Fly ash | fume | agent | Aggregate | Defoamer | Water |
| Variable: | 1 | 1.0 | 0.2 | 0.3 | 0.15 | 4.0 | 0.001 | 0.2 |
| portland | 2 | 1.5 | 0.2 | 0.3 | 0.15 | 4.0 | 0.001 | 0.2 |
| cement | 3 | 2.0 | 0.2 | 0.3 | 0.15 | 4.0 | 0.001 | 0.2 |
| | Comparative | 2.2 | 0.2 | 0.3 | 0.15 | 4.0 | 0.001 | 0.2 |
| | example | | | | | | | |
| Variable: | 4 | 1.0 | 0.2 | 0.3 | 0.15 | 3.5 | 0.001 | 0.2 |
| aggregate | 5 | 1.0 | 0.2 | 0.3 | 0.15 | 4.0 | 0.001 | 0.2 |
| | 6 | 1.0 | 0.2 | 0.3 | 0.15 | 6.0 | 0.001 | 0.2 |
| | Comparative | 1.0 | 0.2 | 0.3 | 0.15 | 6.5 | 0.001 | 0.2 |
| | example | | | | | | | |

For the above embodiments and comparative examples, the present disclosure gives the specific test results as follows:

TABLE 6

| | | Compression | Water |
|---|---|---|---|
| Number of embodiments and | | strength | permeability |
| comparative examples | | (MPa) | (mm/s) |
| Variable: | 1 | 32 | 5.5 |
| portland | 2 | 35 | 4.2 |
| cement | 3 | 38 | 2.1 |
| | Comparative example | 45 | 0.8 |
| Variable: | 4 | 35 | 3.1 |
| aggregate | 5 | 32 | 5.5 |
| | 6 | 28 | 8.5 |
| | Comparative example | 18 | 10.0 |

According to the Above Test Results:

1. For Portland Cement

The cement is used as a binding material of the lower structural layer, which directly affects the strength and water permeability of the lower structural layer. When the amount of the cement is too small, the binding material is insufficient, and the bonding between the cement and the aggregate is not firm, which will lead to a decrease of strength. When the amount of the cement is too high, there are excessive binding materials, and interstices that should exist will be blocked, which will eventually lead to a decrease of the water permeability. It can be seen from Embodiment 1 to Embodiment 3 that when the part by weight of the cement material is in the range of 1.0 to 2.0, the water permeability decreases from 5.5 mm/s to 2.1 mm/s due to increase in cement content, and the compression strength steadily increases from 32 MPa to 38 MPa. As the requirement for the water permeability of the lower structural layer is higher than that for the water permeability of the upper surfacing layer, the water permeability of 2.1 mm/s is within an acceptable range. However, when the part by weight of cement material reaches 2.2 in a comparative example, the corresponding water permeability drops sharply to 0.8 mm/s, which is inadequate to meet the requirements of the pervious pavement. Therefore, in the lower structural layer of the present disclosure, the amount of the cement is selected by weight in the range of 1.0-2.0, which gives consideration to both the performance of water permeability and strength, and is practically a better solution.

2. For Aggregate

The aggregate selected for the lower structural layer is crushed rock with a particle size of 5-10 mm. Compared with the upper surfacing layer, the aggregate of the lower structural layer is much larger in size, so the water permeability of the lower structural layer can be relatively higher. It can be seen from Embodiment 4 to Embodiment 6 that the amount of aggregate will also affect the strength and the water permeability of lower structural layer. The part by weight of the aggregate selected in the present disclosure is within a range of 4-6, which also gives consideration to both the performance of water permeability and strength, and is practically a better solution.

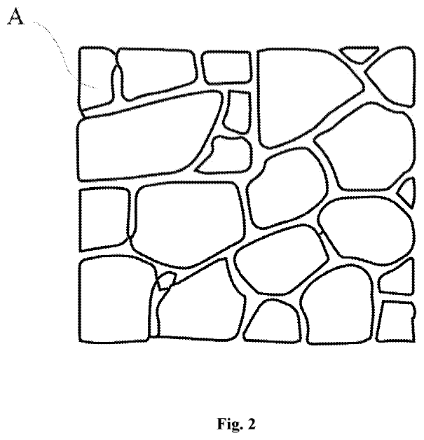

In the present disclosure, the aggregate of the lower structural layer can also be waste glass. To sum up, controlling the diameter of the aggregate of the lower structural layer within 5-10 mm can ensure that the lower structural layer has sufficient water permeability. The specific reason is that, as shown in FIG. 2, the lower layer of the present disclosure forms a pervious concrete structure. There are a lot of interconnected interstices among the aggregates of the lower structural layer. When it rains, rainwater can easily penetrate and pass through the cement-based pervious pavement structure of the present disclosure along these interstices. Because there is almost no sand to fill gaps in the cement-based pervious pavement structure of the present disclosure, the overall water permeability of the lower structural layer and also the cement-based pervious pavement structure can be higher. Therefore, the problem of flooding caused by stagnant water can be well solved. Because there is no stagnant water on the road surface, it can also prevent mosquitoes from laying eggs on the stagnant water and reduce mosquito-borne diseases.

It is worth mentioning that the present disclosure adopts a double-layer structure of the upper layer and the lower layer, and the double-layer structure has a substantial innovative consideration. Firstly, the price of the titanium dioxide material is very expensive compared with other components. If the titanium dioxide is doped throughout the thickness of the entire structure, the overall cost of the cement-based pervious pavement structure will be extremely high. Secondly, for the lower structural layer, adopting larger diameter aggregate can obviously increase the water permeability. However, adopting too large aggregate in the upper surfacing layer will, in turn, easily lead to the rough riding surface of the cement-based pervious pavement structure, which is unsightly and difficult to meet the requirements.

Therefore, through the double-layer structure, the present disclosure combines the advantages of the upper layer and the lower layer, so that the cement-based pervious pavement structure not only has a high water permeability, but also can give consideration to both aesthetics and cost. It is worth mentioning that the upper surfacing layer can also be doped with pigments to satisfy aesthetic design and a color diversity.

It is worth mentioning that the thickness of the upper surfacing layer can be less than or equal to 5 mm. The smaller the thickness of the upper surfacing layer, the less the amount of the titanium dioxide, and the lower the cost. Moreover, when the relatively dense upper surfacing layer has a smaller thickness, the overall water permeability of the cement-based pervious pavement structure can be higher, and in the present disclosure, it can be as high as 77 mm/hr. Such a high water permeability can better meet the requirements of an urban drainage system. Moreover, due to the relatively dense upper surfacing layer being provided, it can well filter the solid content and debris in rainwater, such as leaves, silt, municipal waste, gravel and so on. The solid content in rainwater passing through cement-based pervious pavement structure will be less than 1%. And the solid content remaining on the surface of the upper surfacing layer can be easily cleaned by means of a cleaning vehicle.

In addition, optionally, the ratio of the thickness of the upper surfacing layer to the thickness of the lower structural layer may be within the range of 1:49 to 1:9. When the thickness of the upper surfacing layer is less than or equal to 5 mm, this thickness ratio can ensure that the cement-based pervious pavement structure has a sufficient loading capacity. According to calculation, the compressive strength of the cement-based pervious pavement structure within said range can be higher than 28 MPa, so it can allow for passing of ordinary vehicles.

In the prior art, a drainage channel is usually provided at the roadside, and a drainage cover is provided upon the drainage channel. In addition to the drainage channel at the roadside, there is often a manhole covers on top of manholes connected with drainage pipes along the road. The drainage cover and the manhole cover are often provided with a metal frame, or themselves are made of metal. They are easy to rust under wind, sun and rain, and are very heavy to cause fatigue and potential injury during manual handling.

In addition, in the prior art, grating or opening is usually provided at the drainage cover so that rainwater can pass through. However, the grating or opening is easy to get stuck by the debris that come with the rainwater, resulting in stagnant water after the rain. However, after the rain, a plash is the best place for mosquitoes to lay eggs. The stagnant water is favourable habitat for the breeding of larvae and increases the probability of spreading infectious diseases with mosquitoes as the intermediate carrier.

In view of this, another embodiment of the present disclosure proposes the application of the cement-based pervious pavement structure of the previous embodiment to the drainage cover of the drainage channel or the manhole cover of drainage system. That is, the cement-based pervious pavement structure can be used as the drainage cover or the manhole cover. When act as the drainage cover, a recommended size of the drainage cover is 400 (W)*300 (L)*50 (T) mm.

Optionally, no through hole is provided on the cement-based pervious pavement structure of the present disclosure. When used as the drainage cover or manhole cover, it has a good sealing performance compared with the traditional drainage cover with grating or opening. The cement-based pervious pavement structure can prevent stagnant water, and also prevent mosquitoes from entering and leaving the drainage system through the opening, so the mosquito prevention effect is more outstanding compared to the drainage cover in the prior art.

It can be considered that when the cement-based pervious pavement structure provided by the present disclosure is used as the drainage cover or manhole cover, it is equivalent to have a smart drainage cover that is ecological and can participate in the breathing of the city, and is an innovative and sustainable product. Because the cement-based pervious pavement structure provided by the present disclosure is made up of hydraulic cement, aggregate, various recycled materials and functional additives, and does not require a metal frame, there is no metallic corrosion and aging problems. As titanium dioxide particles are provided in the upper surfacing layer, the cement-based pervious pavement structure can also play a role in photocatalytic purification of car exhaust when it is provided near highways. Because of its extremely high water permeability, the cement-based pervious pavement structure can withstand the weather condition level of black rainstorm when it is applied to the drainage cover or manhole cover. More importantly, due to the sufficient water permeability, there is no need to provide a through hole in the structure, which not only enhances the loading capacity of the structure itself, but also prevents mosquitoes from entering and leaving the drainage system through the opening. That is to say, the cement-based pervious pavement structure of the present disclosure can achieve the advantages of blocking mosquito spawning, blocking the spread of diseases such as malaria, Japanese encephalitis and dengue fever, and improving the biological environment.

As a cost-effective, multi-functional and healthy product, the cement-based pervious pavement structure of the present disclosure can replace the existing traditional drainage cover and expand a new market for building materials. At present, the product of the present disclosure has been tried in a number of areas, and the effect and response are very good.

Yet another embodiment of the present disclosure proposes a manufacturing method of the cement-based pervious pavement structure of the aforementioned embodiment, including the following steps:
placing a concrete mixture for the lower structural layer in a mold, and applying vibration;
applying pressure to compact the concrete mixture for the lower structural layer to form the intact lower structural layer;
placing a concrete mixture for the upper surfacing layer in the mold and above the lower structural layer, and applying vibration; and
applying pressure to compact the concrete mixture for the upper surfacing layer to form the intact upper surfacing layer.

The vibrating, mixing and pressing (applying pressure) can be carried out by automatic vibratory pressing machine. Generally speaking, the cement-based pervious pavement structure of the present disclosure can be produced through traditional processes of raw material mixing, mold feeding, compaction, demoulding and curing.

Specifically, the raw materials of the lower layer and the surface layer can be separately supplied to the automatic vibratory pressing machine. The raw materials are respectively mixed by an electrical mixer. The material of the lower structural layer is then first placed on the designed mold, the mold is vibrated to be filled with the raw material, and then the raw material in the mold is compacted. The material of the lower structural layer is arranged on the mold for the second time, the mold is vibrated to be filled with the material, and then the material in the mold is compacted. After demoulding, the product can be delivered for curing.

The difference from the prior art is that the cement-based pervious pavement structure of the present disclosure is a double-layer structure, so a scheme of step-by-step compaction is adopted. That is, after the compaction of the lower structural layer is completed, the mixture of the upper surfacing layer is placed and vibrated on top of the lower structural layer, and then the compaction is carried out. This operation can prevent unexpected mixing of the upper surfacing layer and the lower structural layer which will result in performance degradation. Furthermore, because the material of the upper surfacing layer is immediately arranged above the compacted lower structural layer, only one demoulding is required in the whole production process, which simplifies the production steps and reduces the cost.

To sum up, the present disclosure adopts nano-level functional modifier and modern concrete technology, adopts an innovative and sustainable design of high-performance pervious concrete core, and adopts modern concrete production technique, various recycled materials, functional additives and other materials, and finally a cement-based pervious pavement structure with compressive strength higher than 28 MPa, water permeability higher than 77 mm/hr and filtered rainwater solid content at least ≤1% can be obtained.

The present disclosure also adopts technologies such as nano-modification technology, cement materials, inorganic-based pigments, recycled waste glass cullets, and nano-level functional modifiers, as well as the upper surfacing layer designed for mosquito oviposition prevention, which can greatly reduce the mosquito oviposition rate in the environment, ensure the removal rate of nitrogen oxides (NOx) to be at least ≥1 mg/m²/hr, and the pendulum sliding resistance BPN to be ≥45, with excellent technical parameters.

For those skilled in the art, it is obvious that the present disclosure is not limited to the details of the above exemplary embodiments, and the present disclosure can be implemented in other specific forms without departing from the spirit or essential characteristics of the present disclosure. Therefore, for every point, the embodiments should be regarded as exemplary and non-restrictive. The scope of the present disclosure is defined by the appended claims rather than the above description, so all changes that fall within the meaning and range of the equivalent elements of the claims are intended to be embraced by the present disclosure. Any reference signs in the claims should not be regarded as limiting the claims involved.

What is claimed is:

1. A cement-based pervious pavement structure, comprising:
a lower structural layer, as a base; and
an upper surfacing layer, overlaid on the lower structural layer, and comprising following components in parts by weight:
1.0-2.0 parts by weight of upper layer aggregate;
0.40-0.70 part by weight of cement;
0.02-0.03 part by weight of titanium dioxide;
0.03-0.04 part by weight of water reducing agent; and
0.001-0.002 part by weight of defoamer.

2. The cement-based pervious pavement structure according to claim 1, wherein the upper layer aggregate comprises waste glass, and a particle size of the upper layer aggregate is within a range of 1.18-2.36 mm.

3. The cement-based pervious pavement structure according to claim 1, wherein a thickness of the upper surfacing layer is less than or equal to 5 mm.

4. The cement-based pervious pavement structure according to claim 1, wherein the lower structural layer comprises following components in parts by weight:
4.0-6.0 parts by weight of lower layer aggregate;
1.0-2.0 parts by weight of portland cement;
0.15-0.30 part by weight of fly ash;
0.20-0.50 part by weight of silica fume;
0.10-0.25 part by weight of the water reducing agent; and
0.001-0.002 part by weight of the defoamer;
wherein a particle size of the lower layer aggregate is within a range of 5-10 mm.

5. The cement-based pervious pavement structure according to claim 1, wherein a ratio of a thickness of the upper surfacing layer to a thickness of the lower structural layer is within a range of 1:49 to 1:9.

6. The cement-based pervious pavement structure according to claim 5, wherein no through hole is provided on the cement-based pervious pavement structure.

7. The cement-based pervious pavement structure according to claim 1, wherein a pendulum sliding resistance (BPN) of the upper surfacing layer is greater than or equal to 45, and a removal rate of nitrogen oxides (NOx) of the upper surfacing layer is ≥1 mg/m²/hr.

8. The cement-based pervious pavement structure according to claim 1, wherein a compressive strength of the cement-based pervious pavement structure is higher than 28 MPa;
solid content in rainwater passing through the cement-based pervious pavement structure is less than 1%; and
a water permeability of the cement-based pervious pavement structure is higher than 77 mm/hr.

9. An application of the cement-based pervious pavement structure according to claim 1 on a drainage cover of a drainage channel or a manhole cover of a drainage system.

10. A manufacturing method of cement-based pervious pavement structure according to claim 1, comprising:
placing a concrete mixture for the lower structural layer in a mold, and applying vibration;
applying pressure to compact the concrete mixture for the lower structural layer to form the intact lower structural layer;
placing a concrete mixture for the upper surfacing layer in the mold and on top of the lower structural layer, and applying vibration; and
applying pressure to compact the concrete mixture for the upper surfacing layer to form the intact upper surfacing layer.
